(19) United States
(12) Patent Application Publication
(10) Pub. No.: US 2007/0013664 A1
(43) Pub. Date: Jan. 18, 2007

(54) Keypad, keypad assembly and portable terminal

(75) Inventors: Joo-Hoon Lee, Yongin-si (KR); Sun-Tae Jung, Anyang-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/481,443

(22) Filed: Jul. 6, 2006

(30) Foreign Application Priority Data
Jul. 15, 2005 (KR) 2005-64348

(51) Int. Cl. G09G 5/00

(52) U.S. Cl. 345/168

(57) ABSTRACT

A keypad including a light guide layer in which light travels, and at least one key button disposed on an upper surface of the light guide panel. The key button may be attached on the upper surface of the light guide panel by means of an adhesive member which has a refractive index disrupting the reflective condition of the light traveling in the light guide panel. The key button may also be disposed on an upper surface of the light guide panel and at least one reflective pattern formed on the light guide panel and partially reflecting the light traveling in the light guide panel toward the key button.

This application claims priority to an application entitled “Keypad, Keypad Assembly and Portable Terminal,” filed in the Korean Intellectual Property Office on Jul. 15, 2005, and assigned Ser. No. 2005-64348, the contents of which are hereby incorporated by reference.

### BACKGROUND OF THE INVENTION

1. Field of the Invention

The present invention relates to a keypad with which a portable terminal, for example, is provided, and more particularly to a keypad with a light guide panel, and a keypad assembly.

2. Description of the Related Art

A keypad used in a conventional portable terminal generally includes a plate-like elastic pad, a plurality of key buttons which are formed on an upper side of the elastic pad, and each of which has characters (letters, numerals or symbols) printed on its upper surface, and a plurality of protrusions (or actuators) formed on a lower surface of the elastic pad, located opposite the upper surface. Also, it is normal for the portable terminal to have a plurality of light emitting devices (usually 15 to 20 in number) for backlighting the keypad.

FIG. 1 illustrates a sectional view of a keypad assembly of the prior art. The keypad assembly 100 includes a keypad 110, a switch board 150 and a plurality of light emitting diodes (hereinafter referred to as “LED”) 170.

The keypad 110 includes a plate-like elastic pad 120, a plurality of key buttons 140 which are formed on an upper surface 122 of the elastic pad 120 and each of which has characters (letters, numerals or symbols) printed on its upper surface, and a plurality of protrusions 130 formed on a lower surface 124 of the elastic pad 120, located opposite the upper surface 122. Each protrusion 130 on the lower surface 124 of the elastic pad 120 is arranged in a position corresponding to a center of each key button 140. A plurality of grooves 126 may be formed on the lower surface 124 of the elastic pad 120. The grooves 126 are disposed around the respective protrusions 130 so as to avoid interferences between the light emitting diodes 170 and the protrusions 130.

The switch board 150 has a plate-like printed circuit board (hereinafter referred to as “PCB”) 155 and a plurality of switches 160 formed on an upper surface, facing the keypad 110, of the PCB 155. Each switch 160 consists of an electrically conductive contact member 162 and an electrically conductive dome 164 completely covering the contact member 162.

The plurality of light emitting diodes 170 are mounted on the upper surface of the PCB 155, and are positioned such that each of them is covered with a corresponding groove 126 of the elastic pad 120.

If a user pushes down any one key button 140, a portion of the keypad 110, located under the key button 140, is deformed onto the switch board 150, and thus a corresponding protrusion 130 belonging to the deformed portion of the keypad 110 presses a corresponding dome 164. The pressed dome 164 comes into electrical contact with a corresponding contact member 162.

For operating the switches 160, each light emitting diode 170 may not be located under the corresponding key button 140. Thus, light emitted from each light emitting diode 170 obliquely illuminates the corresponding key button 140 after passing through the elastic pad 120. On this account, there is a problem in that the key button 140 is not uniformly and/or darkly illuminated. In other words, a central portion of each key button 140 is illuminated less than an edge portion of the key button 140 which is relatively brightly illuminated. In such a configuration, it may be possible to increase the number of light emitting diodes so as to provide uniformly and brightly illuminated key buttons 140, however there would be a prohibitive increase in power consumption and manufacturing cost.

### SUMMARY OF THE INVENTION

Accordingly, the present invention has been made to address at least the above- mentioned shortcomings of the prior art and provides additional advantages, by providing a keypad, a keypad assembly and a portable terminal, which can realize uniform and bright illumination, small power consumption and low manufacturing cost.

In accordance with one aspect of the present invention, there is provided a keypad comprising: a light guide panel through which light travels; and at least one key button being disposed on an upper surface of the light guide panel, wherein the key button is attached on the upper surface of the light guide panel by means of an adhesive member which has a refractive index disrupting a reflective condition of the light traveling in the light guide panel.

In accordance with another aspect of the present invention, there is provided a keypad comprising: a light guide panel into which light travels; at least one key button being disposed on an upper surface of the light guide panel; and at least one reflective pattern being locally formed on the light guide panel and partially reflecting the light traveling in the light guide panel toward the key button.

### BRIEF DESCRIPTION OF THE DRAWINGS

The above and features and advantages of the present invention will be more apparent from the following detailed description taken in conjunction with the accompanying drawings, in which:

FIG. 1 is a sectional view of a conventional keypad assembly;

FIG. 2 is a sectional view of a keypad assembly in accordance with a first exemplary embodiment of the present invention;

FIG. 3 is a plan view of a part of the keypad assembly shown in FIG. 2;

FIG. 4 is a sectional of a keypad assembly in accordance with a second exemplary embodiment of the present invention;

FIG. 5 is a plan view of a comparative example with respect to a third exemplary embodiment of the present invention; and

FIG. 6 is a plan view of a part of a keypad assembly in accordance with the third exemplary embodiment of the present invention.

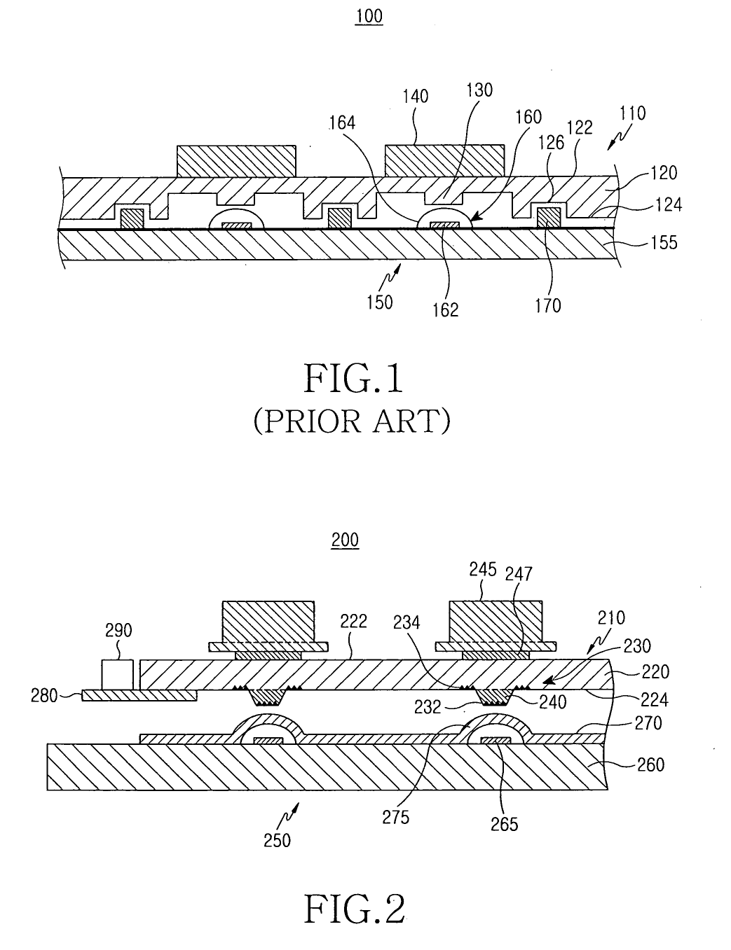

### DETAILED DESCRIPTION

Hereinafter, embodiments of the present invention will be described with reference to the accompanying drawings. It should be noted that similar components are designated by similar reference numerals although they are illustrated in different drawings. For the purposes of clarity and simplicity, a detailed description of known functions and configurations incorporated herein will be omitted when it may obscure the subject matter of the present invention.

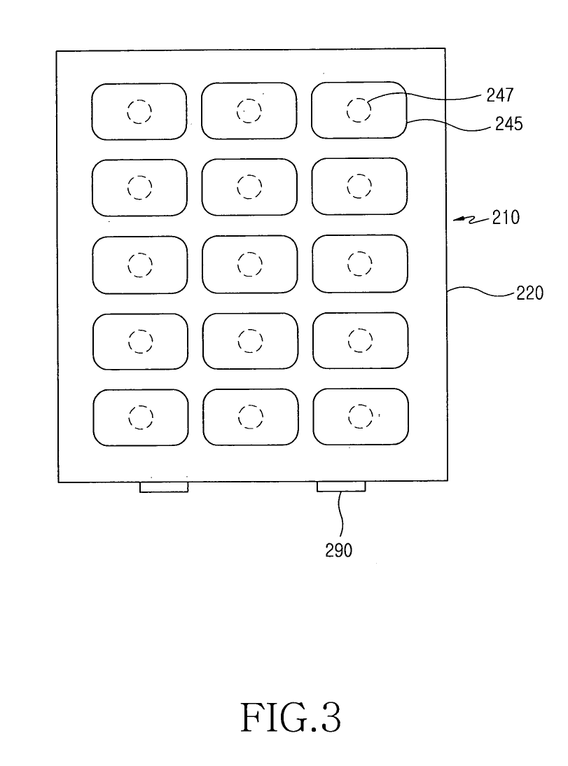

FIG. 2 illustrates a sectional view of a keypad assembly in accordance with a first embodiment of the present invention, and FIG. 3 illustrates a part of the keypad assembly in a plan view.

The keypad assembly 200 includes a keypad 210, a switch board 250 disposed opposite the keypad 210 (and preferably in contact with protrusions 240 of the keypad 210), at least one light emitting device 290, and a second PCB 280.

The keypad 210 includes a light guide panel 220, a plurality of key buttons 245, a plurality of protrusions 240, and a plurality of reflective patterns 230 (designated by triangles inside of which are filled with a black color in FIG. 2).

The light guide panel 220 guides light coupled into it. The coupled light travels from one side to the other side of the light guide panel 220. The light guide panel 220 may have any shape, including a rectangular plate-like shape, for example. Light coupled into the light guide panel 220 travels into the light guide panel 220 by virtue of a substantially total reflection at an interface between the light guide panel 220 and an air layer external thereto. Since the light guide panel 220 has elasticity, it returns the key buttons 245 to their respective original positions after the key buttons 245 are pushed down by a user. That is, the light guide panel 220 itself has a restoring force by which it is restored to its original shape, so it returns the key buttons 245 to their original positions after the key buttons 245 are operated.

A type of light guide panel may be manufactured by means of injection molding polycarbonate or acryl-based resin having high transmissivity to a visible ray. However this type of injection-molded light guide panel may not provide a good click feeling when operating the key buttons 245 because it has low elasticity, a low elastic restoring force and high hardness. Other problems may include an interference phenomena between key buttons (a phenomenon in which adjacent key buttons are simultaneously operated when any one key button is operated) and permanent deformation caused by repetitive operations. However this type of light guide panel may function to provide illumination to the key buttons 245.

The light guide panel 220 in an exemplary embodiment is formed of a material having low hardness, a high elastic strain, a high elastic restoring force and high optical transparency, for example a transparent rubber. Thus, the light guide panel 220 may provide a good click feeling, suppress the interference phenomena between the key buttons 245, and not cause permanent deformation after repetitive operation. Non limiting examples of the material for forming the light guide panel 220 include a transparent rubber, polyurethane and silicon.

The plurality of key buttons 245 are disposed on an upper surface 222 of the light guide panel 220, and letters, numerals and/or symbols are printed on upper surfaces of the key buttons 245. Each of the key buttons 245 may be attached on the upper surface 222 of the light guide panel 220, for example by a corresponding adhesive member 247. The adhesive member 247 has a refractive index which disrupts the reflection of light traveling in the light guide panel 220. In other words, light incident in the light guide panel 220 satisfies the substantially total reflective condition at the interface between the light guide panel 220 and the air layer. But the interface between the light guide panel 220 and the adhesive member 247 is formed to disrupt this total reflective condition and therefore does not satisfy the substantially reflective condition in the light guide panel 220 at the interface between the light guide panel 220 and the adhesive member 247. Thus, the light not satisfying the reflective condition at the interface between the light guide panel 220 and the adhesive member 247 transmits through the adhesive member 247 and the key button 245, and then exits out of the key button 245.

In addition light passing by the adhesive member without being incident into the adhesive member 247 continues to travel in the light guide panel 220 to contribute to the illumination of the other key buttons. The luminous intensity of light transmitting through the adhesive member 247 increases as the refractive index of the adhesive member approaches that of the light guide panel 220. For example, the refractive index of the adhesive member 247 may be set to a value equal to or less than that of the light guide panel 220. Non limiting examples of the adhesive member 247 include double sided tape or adhesive.

Each key button 245 may be made of the same material as that of the light guide panel 220, or other non limiting examples include polycarbonate or acryl-based resin. Each key button 245 may be formed in any shape, for example, in the shape of a cylinder, an elliptic cylinder, etc.

The plurality of protrusions 240 are disposed on a lower surface 224 of the light guide panel 220, located opposite the upper surface 222. The protrusions 240 may be made of the same material as or of different material from that of the light guide panel 220 and may be formed as a one-piece component with the light guide panel 220, or may be separately formed and then attached onto the lower surface 224 of the light guide panel 220. Each protrusion 240 may be formed in any shape, for example, in the shape of a truncated cone, a trapezoidal hexahedron, etc. Each protrusion 240 is aligned under the corresponding key button 245 (in a widthwise direction of the keypad assembly 200 or in a direction perpendicular to an upper surface of a first PCB 260).

The keypad 210 is formed on the lower surface of the light guide panel 220, and has a plurality of reflective patterns 230, each of which reflects a part of light traveling into the light guide panel 220 toward the corresponding key button 245. Examples of forming each reflective pattern 230 include forming on the upper surface of the light guide panel 220 or disposing them between the light guide panel 220 and the corresponding protrusion 240. By forming each reflective pattern 230 in and around the protrusion 240 located beneath the corresponding key button 245 a more uniform illumination of the key buttons 245 may result. In addition by varying the density or size of the reflective patterns 230 between reflective patterns located relatively near the light emitting device 290 in contrast to reflective patterns located relatively further away from the light emitting device 290 over the whole keypad 210, it is possible to adjust the overall distribution of the luminous intensity of the light exiting from the upper side of the light guide panel 220 regardless of a distance between the reflective pattern 230 and the light emitting device 290. For example, when the luminous intensity of the exiting light is relative large at a location relatively near the light emitting device 290, a low density of reflective patterns may be located at locations relatively near the light emitting device 290. In contrast, when the luminous intensity of the exiting light is relative small at a location relatively further away from the light emitting device 290, a high density of reflective patterns may be located at locations relatively further away from the light emitting device 290. In this way, the overall luminous intensity of the exiting light, for example, the overall illumination distribution of the key buttons 245 can become uniform and bright.

A central portion 232 of each reflective pattern 230 is formed on a lower surface of the corresponding protrusion 240, and an edge portion 234 of the reflective pattern 230 around the protrusion 240. As shown in the drawing FIG. 2, light traveling into the light guide panel 220 by virtue of the substantially total reflection is incident to the reflective pattern 230 and is diffuse-reflected toward the key button 245. Since most of the light diffuse-reflected by the reflective pattern 230 does not satisfy the substantially total reflection condition (that is, an incident angle is smaller than a threshold angle), it transmits through the corresponding key button 245 to exit out of the key button 245.

The illumination of other key buttons is achieved by light passing by the reflective 20 pattern 230 without being diffuse-reflected thereby and also by a part of the diffuse-reflected light which continues to travel in the light guide panel 220 rather than transmitting through the corresponding key button 245. In other words, the reflective pattern 230 causes diffuse reflection such that only a part of the incident light is used for illuminating the corresponding key button 245 and the remaining part of the incident light is used for illuminating the-other key buttons. The reflective patterns 230 enable uniform illumination of the key buttons 245 through diff-use reflection in random directions. The reflective patterns 245 may be formed, for example by scratching, printing, etc. When the light guide panel 220 includes an optical fiber array, the reflective patterns 250 may extend from a lower surface of the optical fiber array to core surfaces.

In this embodiment of the present invention, the adhesive members 247 and the reflective patterns 230 are useful together or separately as means for providing the exiting the light, which travels in the light guide panel 220 by virtue of substantially total reflection, toward an ambient atmosphere through the key buttons 245. In other words, the adhesive members 247 and the reflective patterns 230 disrupt the reflective condition for the light traveling in the light guide panel 220. Each adhesive member 247 disrupts the reflective condition for light incident to an interface between the adhesive member 247 and the light guide panel 220 by having a controlled refractive index, and each reflective pattern 230 disrupts the reflective condition for light incident to the upper surface of the light guide panel 220 through diffuse-reflection. Desired illumination conditions of the key buttons 245 can be achieved by adjusting the area and refractive index of each adhesive member 247, and the area and density of each reflective pattern 230.

The switch board 250 includes a first PCB 260 and a dome sheet 270.

The first PCB 260 has a plurality of electrically conductive contact members 265 formed on its upper surface and a plurality of domes 275 covering the electrically conductive contact members 265. Each pair of the contact member 265 and the corresponding dome 275 constitutes a switch 265, 275. The switch 265, 275 is aligned under the corresponding protrusion 240.

The dome sheet 270 is attached to the upper surface of the first PCB 260, and is provide with the plurality of electrically conductive domes 275 having a hemispherical shape. Each dome 275 completely covers the corresponding contact member 265.

When a user pushes down any one key button 245, a portion of the keypad 210, located under the key button 245, is deformed onto the switch board 250, and thus a corresponding protrusion 240 belonging to the deformed portion of the keypad 210 presses a corresponding dome 275. The pressed dome 275 comes in electrical contact with a corresponding contact member 265.

The second PCB 280 is attached to an edge portion of the lower surface 224 of the light guide panel 220, and at least one light emitting device 290 is mounted on an upper surface of the second PCB 280 while its light emitting surface faces a side surface of the light guide panel 220. Light exiting from the light emitting device 290 is coupled into the light guide panel 220 through the side surface of the light guide panel 220. An ordinary flexible PCB (FPCB) may be used as the second PCB 280, and an ordinary light emitting diode may be used as the light emitting device 290, as examples.

Variations of this embodiment may include, an edge portion on one side of the light guide panel 220 may slantingly extend in the form of a wedge up to the upper surface of the first PCB 260 while the second PCB 280 is removed. In this case, the light emitting device 290 is mounted on the upper surface of the first PCB 260.

In addition, an edge portion on one side of the light guide panel 220 may be so bent as to extend up to the upper surface of the first PCB 260. In this case, the light emitting device 290 is mounted on the upper surface of the first PCB 260.

Hereinafter, a structure for shielding light leaked from keypad portions other than the key buttons will be described in connection with a second embodiment of the present invention, and a structure for reducing shadow portions of the keypad will be described in connection with a third embodiment of the present invention.

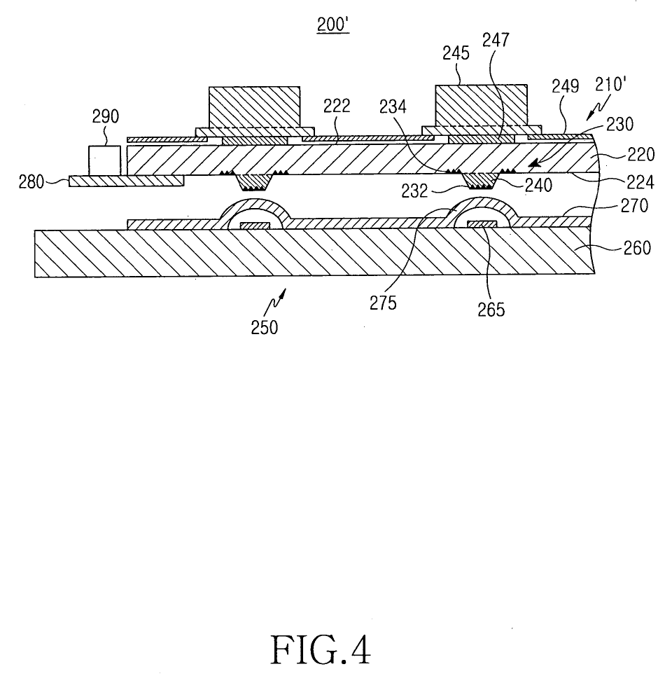

FIG. 4 illustrates a sectional view of a keypad assembly in accordance with the second embodiment of the present invention. The keypad assembly 200′ according to this embodiment has a construction similar to that shown in FIG. 2, except that it further includes a shield member 249. Accordingly, similar reference numerals will be used for the similar components to those in FIG. 2, and a repetitive description thereof will be omitted.

The shield member 249 is disposed on the upper surface of the light guide panel 220, and covers exposed portions of the upper surface of the light guide panel 220. That is, the shield member 249 covers portions on the upper surface of the light guide panel 220 except portions occupied by the key buttons 245. This embodiment helps prevent light from leaking from regions other than the key buttons 245. Examples of the shield member 249 include a black print film or a colored film having low optical transmission properties and may be made of polyurethane or silicone as non limiting examples.

Additionally, the surface of the shield member 249 may be formed without being adhered to the upper surface of the light guide panel 220 in order to maintain an air layer between the light guide panel 220 and the shield member 249. To this end, the surface of the shield member 249 may roughened or may be coated with a release agent so as to have a slippery property.

Variations of this embodiment may include, maintaining an air layer between the shield member 249 and the light guide panel 220 even when the upper surface of the light guide panel 220 is coated with a transparent release agent or other transparent coating materials providing the slippery property, instead of coating the shield member so as to have the slippery property, an air layer can be maintained between the shield member 249 and the light guide panel 220 to prevent unnecessary light loss.

A variation embodiments may include a coating layer having a high reflective color and composed of a component of high reflectivity may be first provided directly on the upper surface of the light guide panel 220, and then the coating layer may be black printed over the coating layer to reduce light leakage from regions other than the key buttons 245.

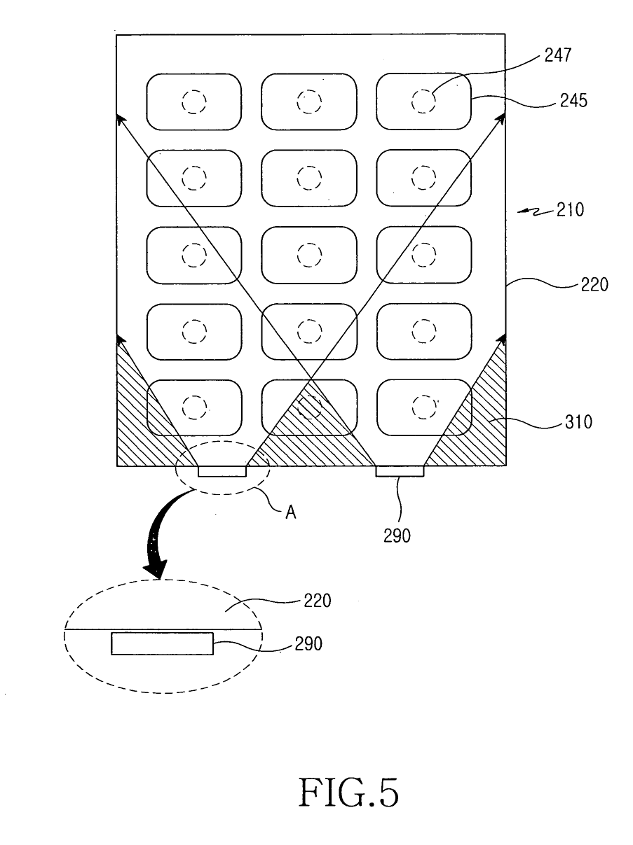

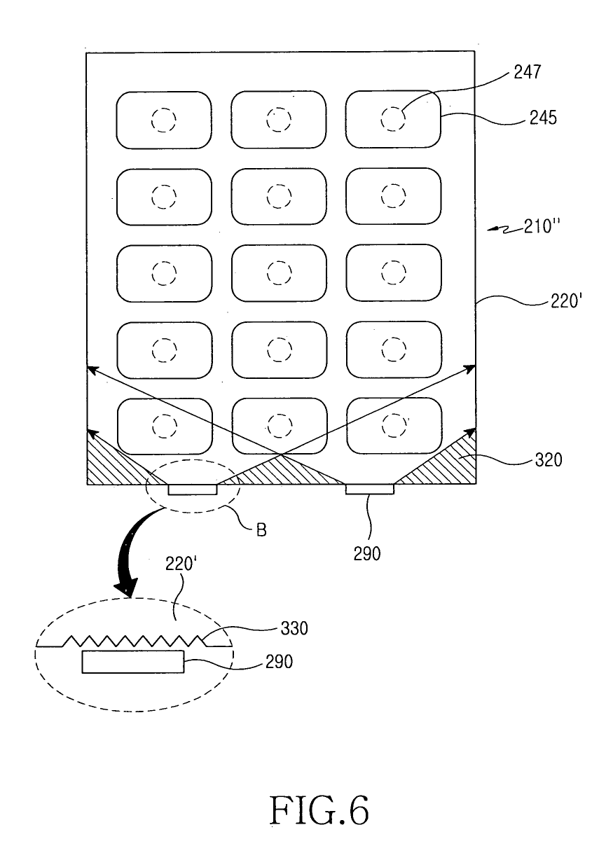

FIG. 6 illustrates a plan view of a part of a keypad assembly in accordance with a third embodiment of the present invention, and FIG. 5 illustrates a comparative example with respect to the third embodiment. The keypad assembly according to the third embodiment has a construction similar to that shown in FIG. 2, except that it further includes a diffusion member 330 on a side surface of the light guide panel 220 as shown in FIG. 6. Accordingly, similar reference numerals will be used for the similar components to those in FIG. 2, and a repetitive description thereof will be omitted.

Referring first to FIG. 5, light beams exiting from the light emitting devices 290 are coupled into the light guide panel 220 through a side surface of the light guide panel 220. Since the light from the respective light emitting devices 290 have a predetermined divergence angle, there occur shadow portions 310 on both sides of the respective light emitting devices 290, where the light beams do not reach.

Next, referring to FIG. 6, a teeth-shaped diffusion member 330 is provided on a side surface of the light guide panel 220′, and the diffusion member has a prism array structure. Light beams incident from the respective light emitting devices 290 onto the diffusion member 330 are diffused by the diffusion member 330, which effectively widens the divergence angle of the light from the light emitting devices 290. Thus, shadow portions formed on both sides of the light emitting devices 290 may be significantly reduced.

As described above, a keypad and a keypad assembly according to the present invention may provide advantages of a more uniform and brighter illumination of key buttons by providing a light guide panel, which may have an elastic nature, between key buttons and protrusions. Other advantages may include a reduction in the number of necessary light emitting devices, power consumption and manufacturing cost.

While the invention has been shown and described with reference to certain embodiments thereof, it will be understood by those skilled in the art that various changes in form and details may be made therein without departing from the spirit and scope of the invention as defined by the appended claims.

What is claimed is:

1. A keypad comprising:
a light guide panel into which light travels; and
at least one key button being disposed on an upper surface of the light guide panel,
wherein the key button is attached on the upper surface of the light guide panel by means of an adhesive member which has a refractive index disrupting a reflective condition of the light traveling in the light guide panel.

2. The keypad as claimed in claim 1, further comprising at least one reflective pattern being locally formed on the light guide panel and partially reflecting light traveling in the light guide panel toward the key button.

3. The keypad as claimed in claim 1, further comprising at least one protrusion being formed on a lower surface of the light guide panel.

4. The keypad as claimed in claim 1, wherein the light guide panel is made of transparent material having elasticity.

5. A keypad comprising:
a light guide panel into which light travels;
at least one key button being disposed on an upper surface of the light guide panel; and
at least one reflective pattern being locally formed on the light guide panel and partially reflecting the light traveling in the light guide panel toward the key button.

6. The keypad as claimed in claim 5, further comprising at least one protrusion being formed on a lower surface of the light guide panel.

7. The keypad as claimed in claim 5 wherein the key button is attached on the upper surface of the light guide panel by means of an adhesive member which has a refractive index disrupting a reflective condition of the light traveling in the light guide panel.

8. A keypad assembly comprising:
a keypad including a light guide panel into which light travels, at least one key button being disposed on an upper surface of the light guide panel and being attached on the upper surface of the light guide panel by means of an adhesive member which has a refractive index disrupting a reflective condition of the light traveling in the light guide panel; and
a switch board being provided, on an upper surface thereof facing the keypad, with at least one switch,
wherein as the key button is pushed down, a portion of keypad is deformed onto the switch to press the switch.

9. The keypad assembly as claimed in claim 8, further comprising at least one light emitting device being disposed in a position facing a side surface of the light guide panel and coupling light into the light guide panel.

10. The keypad assembly as claimed in claim 8, further comprising at least one reflective pattern being locally formed on the light guide panel and partially reflecting light traveling in the light guide panel toward the key button.

11. A keypad assembly comprising:
a switch board being provided on an upper surface thereof with at least one switch;
a keypad including a light guide panel having an upper surface, a lower surface and side surfaces, and at least one key button being disposed on the upper surface of the light guide panel while being positioned above the switch; and
at least one light emitting device being disposed adjacent to at least one of the side surfaces of the light guide panel,
wherein the keypad further includes at least one reflective pattern being formed on a portion of the upper or lower surface of the light guide panel, located under the key button, and partially reflecting light traveling in the light guide panel toward the key button.

12. The keypad assembly as claimed in claim 11, wherein the key button is attached on the upper surface of the light guide panel by means of an adhesive member which has a refractive index disrupting a reflective condition of the light traveling in the light guide panel, and wherein the light guide panel is made of transparent elastic material.

13. The keypad assembly as claimed in claim 11, wherein the keypad further includes at least one protrusion being formed on a lower surface of the light guide panel.

14. A portable terminal comprising:
a terminal body;
a keypad including a light guide panel into which light travels, and at least one key button being disposed on an upper surface of the light guide panel and being attached on the upper surface of the light guide panel by an adhesive member which has a refractive index disrupting a reflective condition of the light traveling in the light guide panel; and
a switch board being provided, on an upper surface thereof facing the keypad, with at least one switch,
wherein as the key button is pushed down, a portion of keypad is deformed onto the switch to press the switch.

15. The portable terminal of claim 14, wherein the keypad further includes at least one reflective pattern being formed on a portion of the upper or lower surface of the light guide panel, located under the key button, and partially reflecting light traveling in the light guide panel toward the key button.

16. The portable terminal of claim 14, further comprising:
a light emitting device coupled to the light guide; and
a diff-user coupled between the light emitting device coupled and the light guide.

17. The portable terminal of claim 14, further comprising:
a shield disposed on the upper surface of the light guide panel, wherein the shield reduces leakage light.
